(19) United States
(12) Patent Application Publication
(10) Pub. No.: US 2025/0229369 A1
(43) Pub. Date: Jul. 17, 2025

(54) LASER STOCK ELEVATED HOLD DOWN

(71) Applicant: ARB Woodworking LLC, Quinton, VA (US)

(72) Inventor: James Bennett, Quinton, VA (US)

(21) Appl. No.: 19/023,169

(22) Filed: Jan. 15, 2025

Related U.S. Application Data
(60) Provisional application No. 63/621,027, filed on Jan. 15, 2024.

(51) Int. Cl. B23K 37/04; B23K 26/70

(52) U.S. Cl. CPC B23K 37/0408; B23K 26/702

(57) ABSTRACT

A laser stock hold down device includes a base having a bottom wall, top wall and at least one side wall arranged therebetween. At least one shelf is connected with the base and arranged above the base bottom wall, and at least one hold down mechanism is connected with an upper surface of the base. A portion of the shelf is arranged within a perimeter of the base, and it is arranged to define at least two horizontal surfaces on which material to be cut or engraved can be secured and elevated above a laser bed. The shelf provides a different distance between each surface and the hold down mechanism.

The present application claims the benefit of U.S. Provisional Application No. 63/621,027 filed Jan. 15, 2024, the entire content of which is incorporated herein by reference.

### BACKGROUND OF THE INVENTION

The present disclosure is directed toward a device for managing materials with a laser cutting or engraving machine, and more particularly to a laser stock elevated hold down device.

Laser cutting and engraving machines, and mechanisms to secure the materials to be cut/engraved are known. Many laser cutting and engraving machines utilize a metal honeycomb bed to support the material stock to be cut/engraved. The laser head passes over the stock and focuses the laser beam downward to cut/engrave the material. Placing stock directly on the bed can result in multiple problems.

One issue with this process is warping/out of focus materials. Various materials, particularly thin plywood (such as ⅛″ or 3 mm thick material), can be warped in shape. The warped nature of the material results in a portion of it being elevated above the bed, which can place that portion out of the focus range of the laser beam. The unfocused laser delivers energy over a wider area, resulting in lower energy density, which can significantly degrade the quality of engraving as well as prevent the laser from cutting through material that it would otherwise be able to cut when properly focused.

A second issue relates to flashback. Laser cutting causes material to melt, vaporize, or burn. The laser must have sufficient energy (influenced by several factors, including power and focus) in order to fully pass through the material to complete a cut. When cutting material on a metal honeycomb bed, the laser beam can reflect off of the bed back up to the underside of the material being cut. This reflected energy can be sufficiently powerful to scorch the underside of the material, which is often undesirable cosmetically, and can sometimes pose a fire risk. A common result of flashback is a crosshatch pattern scorched onto the underside of the material.

A third issue is deposition of vaporized material. When cutting, it is common practice to utilize “air assist,” which is a feature/mechanism by which a stream of air is directed into the cut with the goal of clearing vaporized material. This clears obstructions to the laser beam and cools the remaining material. The vaporized material is then blown through the cut into the cells of the honeycomb bed, which can result in the underside of the piece becoming coated in vaporized material (soot, in the case of wood/plywood). This is undesirable cosmetically, and it can be labor-intensive to remove.

There are various known, partial solutions related to the issues discussed above. For one, magnets are placed on top of the stock material to hold the material flat against the honeycomb bed. This is effective only for beds made of steel, as magnets are not attracted to aluminum. This method can alleviate the warping issue but it is narrow in scope.

Another solution is inserting “L” or “T” shaped pins into the cells of the honeycomb bed to hold the edges of the stock material flat to the bed. These pins are often cut from thin plywood or are 3D printed. They must be sized specifically to fit within the cells of the honeycomb bed, and different laser machine manufacturers (even different machines from the same manufacturer) can utilize different cell sizes. The body/shaft of the pins are wedged into the cells of the honeycomb bed and are then held in place by tension. Placing, removing, or repositioning these pins can be challenging, depending on the level of tension. This method helps alleviate warping.

A third solution involves using “blades” in lieu of a honeycomb bed. A blade bed consists of triangular or sheer vertical components, often made of metal, which support the stock material at the apex of the triangle or the top of the vertical component. A series of blades can thus function as a bed surface, so long as the stock material is of sufficient size to span the gaps between blades. This method partially alleviates flashback and vaporized material deposition issues.

The above methods provide important solutions the issues discussed, but they are narrow in scope and include inefficiencies. Thus, there is a need for new devices which more effectively and efficiently solves the issues of warping, flashback and vaporized materials.

### SUMMARY OF THE INVENTION

Accordingly, it is an object of the present disclosure to provide a laser stock hold down device including a base having a bottom wall, top wall and at least one side wall arranged therebetween. At least one shelf is connected with the base and arranged above the base bottom wall, and at least one hold down mechanism is connected with an upper surface of the base. A portion of the shelf is arranged within a perimeter of the base and is arranged to define at least two horizontal surfaces on which material to be cut or engraved can be secured and elevated above a laser bed. The shelf provides a different distance between each surface and the hold down mechanism.

In one embodiment, the at least one hold down mechanism is movable between a first position for securing material to be cut or engraved and a second position for releasing the material and the hold down mechanism is connected with at least one projection, which is connected with an upper end of the base. Preferably, the hold down mechanism is rotatable or slidable.

In a second embodiment, at least one magnet is arranged within a cavity of the base bottom wall to secure the device to a metal.

In a separate embodiment, the base, at least one magnet and at least one projection each include an aligned through opening. There is a bar arranged in the through opening to connect the base, magnet and projection.

In another embodiment, the shelf includes a plurality of shelves having an L configuration and two hold downs arranged at opposite ends of the shelves.

In a yet another embodiment, at least a portion of an upper surface of the base has a frustum configuration, the hold down mechanism has a rhomboidal configuration, and the at least one shelf includes a plurality of shelves arranged in a generally circular configuration.

In a further embodiment, the projection contains a horizontal through opening having a configuration that corresponds with a configuration of the hold down mechanism.

In yet another embodiment still, the projection includes a pair of opposing inwardly angled sidewalls and the at least one hold down mechanism includes a pair of spaced protrusions arranged on a bottom surface of the hold down mechanism. The protrusions are configured to correspond with the inwardly angled sidewalls of the projection such that the hold down mechanism is connected with the projection via a sliding motion.

### BRIEF DESCRIPTION OF THE DRAWINGS

Other objects and advantages of the disclosure will become apparent from a study of the following specification when viewed in the light of the accompanying drawing, in which:

FIG. 1 is a perspective view of a pair of a first embodiment of hold down devices according to the present disclosure;

FIGS. 2 and 3 are top and bottom perspective views of the device of FIG. 1 with the slidable plate removed;

FIG. 4 is a top perspective view of the slidable plate from the device of FIG. 1;

FIGS. 5 and 6 are perspective views of the device of FIG. 1 with all elements separated;

FIG. 7 is a perspective view of four of the devices from FIG. 1 arranged on a honeycomb and securing material that has been cut;

FIG. 8 is a perspective view of a second embodiment of a hold down device according to the present disclosure;

FIGS. 9 and 10 are top and bottom perspective views of the device of FIG. 8 with the slidable plate removed;

FIGS. 11 and 12 are top and bottom perspective views of the slidable plate from the device of FIG. 8;

FIGS. 13 and 14 are perspective views of the device of FIG. 8 with all elements separated;

FIG. 15 is a perspective view of four of the devices from FIG. 8 arranged on a honeycomb and securing material that has been cut;

FIG. 16 is a perspective view of a third embodiment of a hold down device according to the present disclosure;

FIGS. 17 and 18 are top and bottom perspective views of the device of FIG. 16 with the slidable plate removed;

FIGS. 19 and 20 are top and bottom perspective views of the slidable plate from the device of FIG. 16;

FIGS. 21 and 22 are perspective views of the device of FIG. 16 with all elements separated;

FIGS. 23 and 24 are perspective views of two of the devices of FIG. 16 with the slidable plate in the clamped and unclamped positions, respectively;

FIG. 25 is a perspective view of one device from FIG. 1, two devices from FIG. 16, and one device from FIG. 26 arranged on a honeycomb and securing material that has been cut;

FIG. 26 is a perspective view of a fourth embodiment of a hold down device according to the present disclosure;

FIGS. 27 and 28 are top perspective views of the device of FIG. 26 with the rotatable plate in the clamped and unclamped positions, respectively;

FIG. 29 is a bottom view of the device of FIG. 26;

FIGS. 30 and 31 are perspective views of the device of FIG. 26 with the base, shelf and plate separated;

FIGS. 32 and 33 are perspective views of the device of FIG. 26 with with all elements separated;

FIG. 34 is a perspective view of the device of FIG. 26 along with other hold down devices arranged on a honeycomb and securing material that has been cut;

FIG. 35 is a perspective view of a fifth embodiment of a hold down device according to the present disclosure;

FIGS. 36 and 37 are top and bottom perspective views of the device of FIG. 35 with the slidable plate removed;

FIGS. 38 and 39 are perspective views of the device of FIG. 16 with all elements separated; and

FIG. 40 is a perspective view of two of the devices from FIG. 35 arranged on a honeycomb and securing material that has been cut;

### DETAILED DESCRIPTION

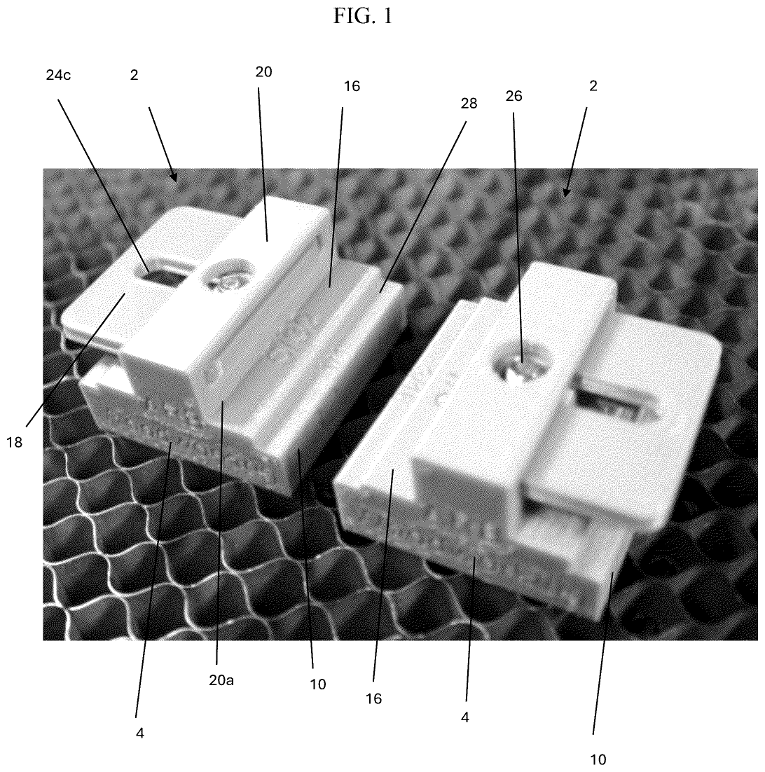

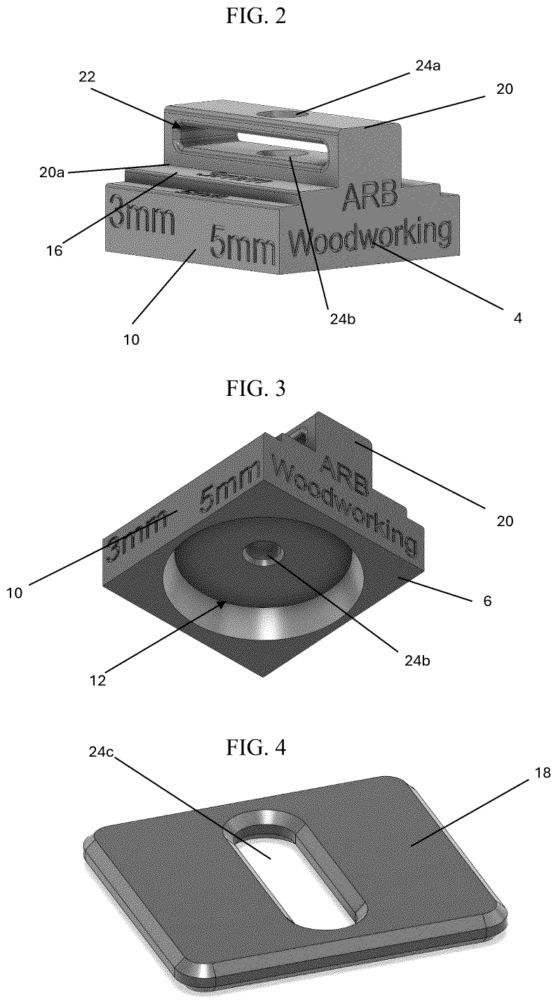

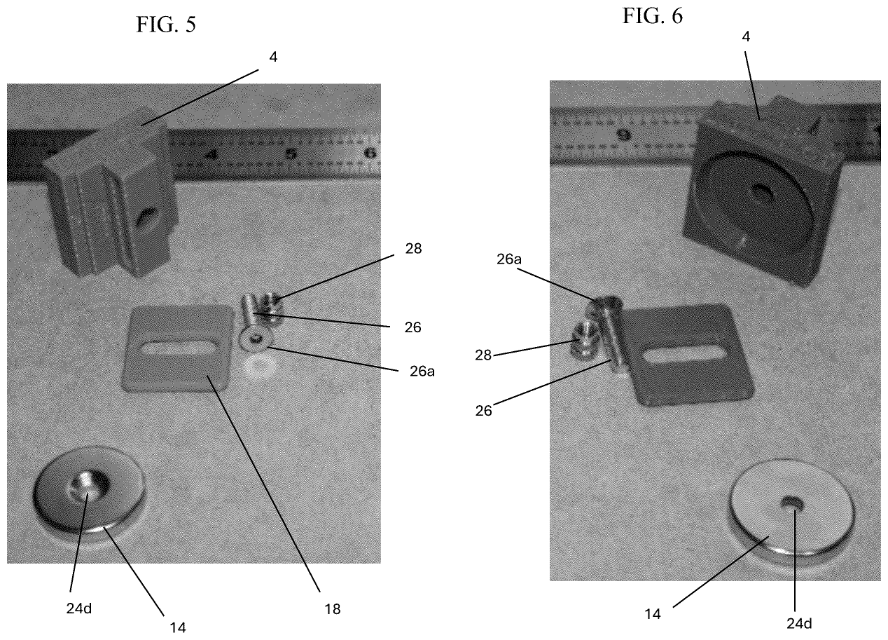

Referring first to FIGS. 1-7, a first embodiment of a hold down device 2 according to the present disclosure is shown. The device includes a base 4 having a lower end 6, upper end 8 and sidewalls 10 therebetween defining a generally cuboidal configuration. As shown in FIG. 3, the lower end portion contains a circular cavity 12 in which a permanent magnet 14 (FIGS. 5 and 6) is attached to attract the device to a steel honeycomb bed when used. The upper end portion has shelves 16 defining an upper end width that is less than a width defined by the sidewalls. A plate 18 connects with an upper end projection 20 to secure material between a shelf 16 and the plate. When the device is placed on a honeycomb, the magnet keeps the device in its place, material is placed on the device, the plate secures the material, and the material can then be cut or engraved.

As shown in FIG. 1-7, the projection 20 extending from and arranged above the uppermost shelf 16 has a length equal to the length of the base 4 and a width less than the width of the base. The lower end 20a of the projection defines the uppermost shelf on opposing sides of the base. The projection contains a horizontal through opening 22 having a rectangular configuration in cross-section. This opening is configured to receive a generally rectangular plate 18 having a width greater than that of the projection but less than that of the base. The projection further contains a vertical through opening 24a which is aligned with a through opening 24b extending vertically through the base and configured to receive an elongated bar 26 having a threaded outer surface, such as a screw or bolt, along with a knurled insert 28 having a threaded inner surface with which the bar is connected. The plate 18 includes a through opening 24c substantially extending the width of the plate. The permanent magnet 14 likewise includes a central through opening 24d that aligns with the base, plate and projection openings 24a, 24b, 24c when inserted into the base lower end circular cavity 12.

When the plate 18 is inserted into the projection horizontal opening 22, and the magnet 14 is inserted into the base lower end cavity 12, the bar 26 is inserted through the magnet opening 24d, through the base opening 24b, through the plate opening 24c, and through the projection vertical opening 24a to connect with the knurled insert 28. The knurled insert is a heat-set insert that must be heated and inserted into the base. The device 2 is then assembled and ready for use. As shown in FIG. 5, the elongated bar includes a flat head 26a having a width that corresponds with the width of the magnet opening 24d such that when the bar is inserted into the device, its head is flush with the magnet outer surface.

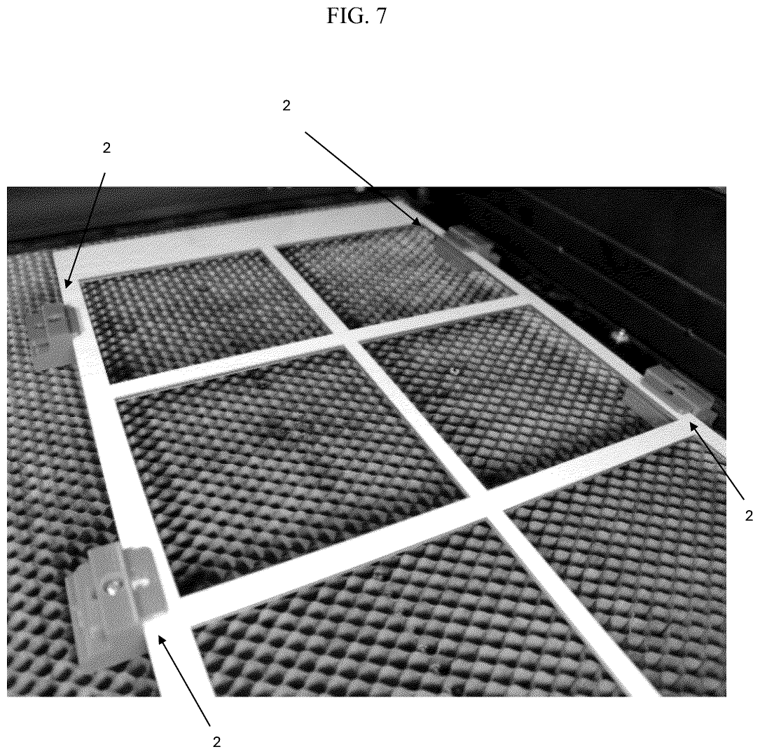

The shelves 16 of the device 2 and the plate 18 define variable thicknesses corresponding to thicknesses of a material to be cut or engraved by a cutting or engraving machine. The shelves are generally sized to either metric thickness materials, for instance 3, 4, 5, or 6 mm, or standard thickness materials, such as ⅛ inch, 5/32 inch, 3/16 inch, or ¼ inch. One version accommodates material up to ½ inch thick. When multiple hold downs are employed, this structure raises the stock material to a consistent elevation above the bed. For example, as shown in FIG. 7, four units 2 are used with two on each side of a rectangular piece of stock material and all sides of the material are held at the same elevation above the bed.

Again, to use the device 2, the plate 16 is slid to one end of the device to expose the shelves 16 (FIG. 1), a piece of material is placed on a shelf corresponding to the material thickness, and then the plate is slid over the material to hold it in place.

The device significantly reduces, and often eliminates, warping, flashback, and deposition. It has the added benefit of ensuring that the top of the material is at a consistent elevation above the honeycomb bed, which eliminates the need to adjust the bed or laser height to recalibrate the focal distance when engraving materials of different thicknesses. The hold downs can also function as alignment tools for rapid replacement of stock materials for manufacturing efficiency.

Preferably the device of FIG. 1-7 includes a neodymium disk countersunk hole magnet (30 mm diameter, 5 mm thick, 5 mm countersunk hole), a knurled brass heat set insert (M5 thread, 8 mm height, 7 mm diameter), and a flat head socket cap screw (M5 thread, 20 mm total length). The maximum stock material thickness for this embodiment is preferably ¼ inch.

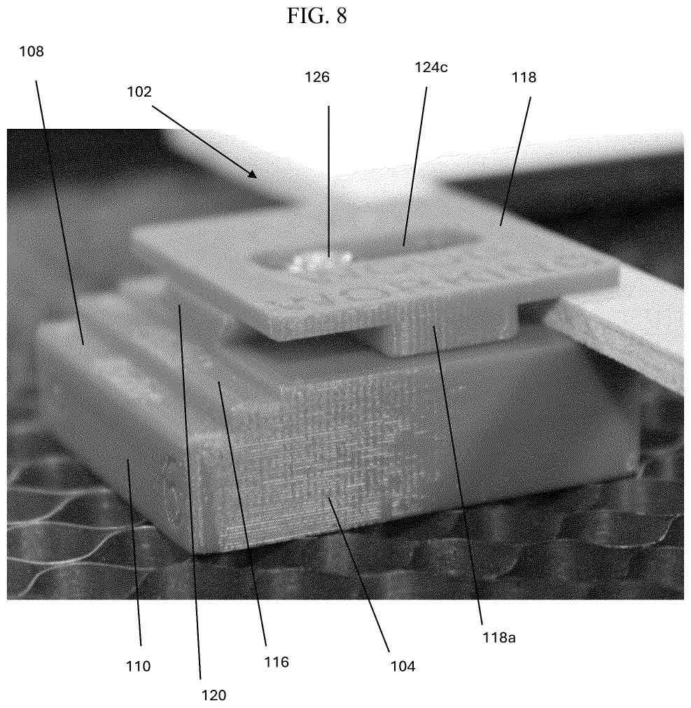

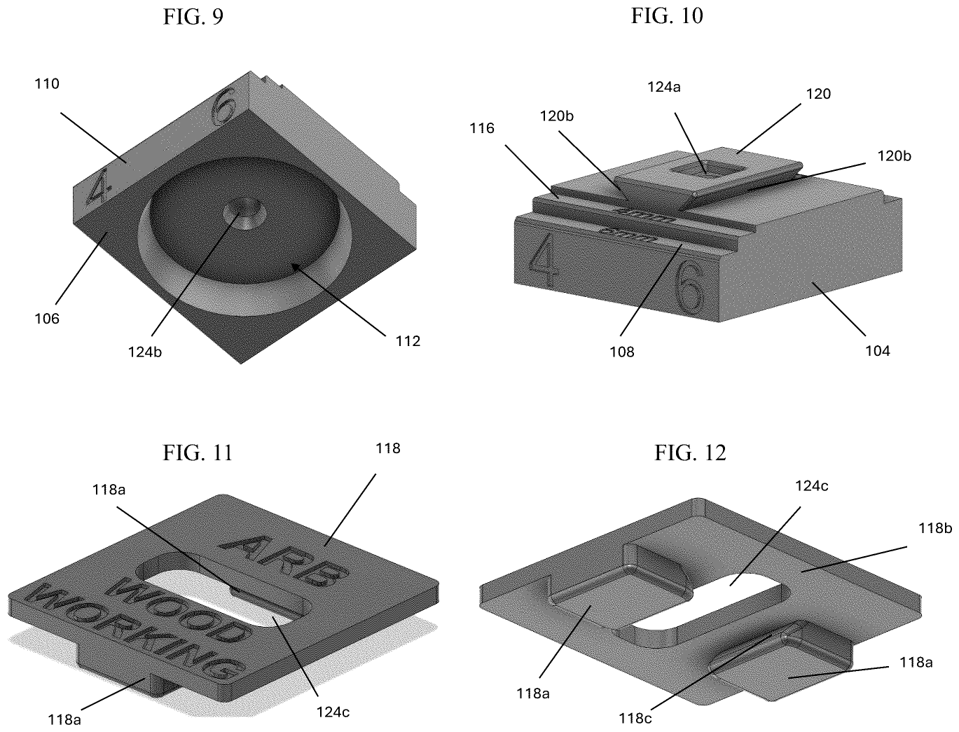

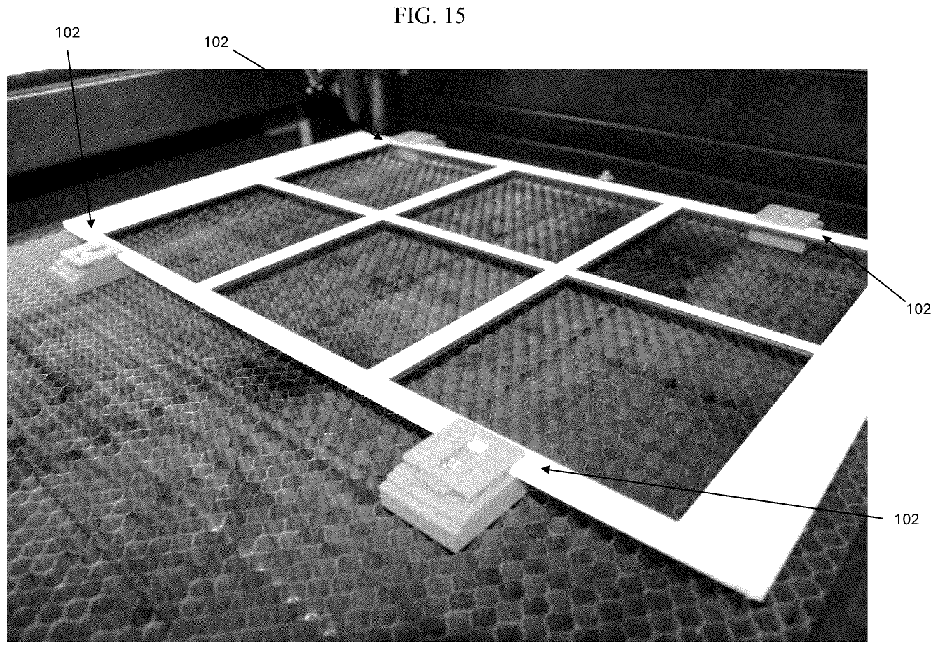

Referring now to FIGS. 8-15, a second embodiment of a hold down device 102 according to the present disclosure is shown. This embodiment, also referred to as the low-profile laser stock elevated hold down, includes a body 104 that is lower than the first embodiment, which is achieved by reducing the upper portion in height and altering the sliding plate to a dovetail sliding tab, rather than a captured sliding tab.

This device 102 also includes a base 104 with lower end 106 containing a cavity 112 with magnet 114, upper end 108 and side walls 110 arranged therebetween. The upper end of the body also includes shelves 116 and a projection 120 with a vertical through opening 124a. The projection of this embodiment, however, does not contain a horizontal through opening, thus reducing its height. Rather, it has a flat upper surface on which a plate 118 containing an elongated through opening 124c is placed. The projection includes a pair of opposing inwardly angled side walls 120b which correspond with sidewalls 118c of protrusions 118a connected with a bottom surface 118b of the plate. The protrusions have a generally rectangular configuration in cross-section and are arranged on opposite sides of the plate opening 124c to align with the projection angled side walls. The plate is slidable along the width of the base to expose and cover the shelves 116.

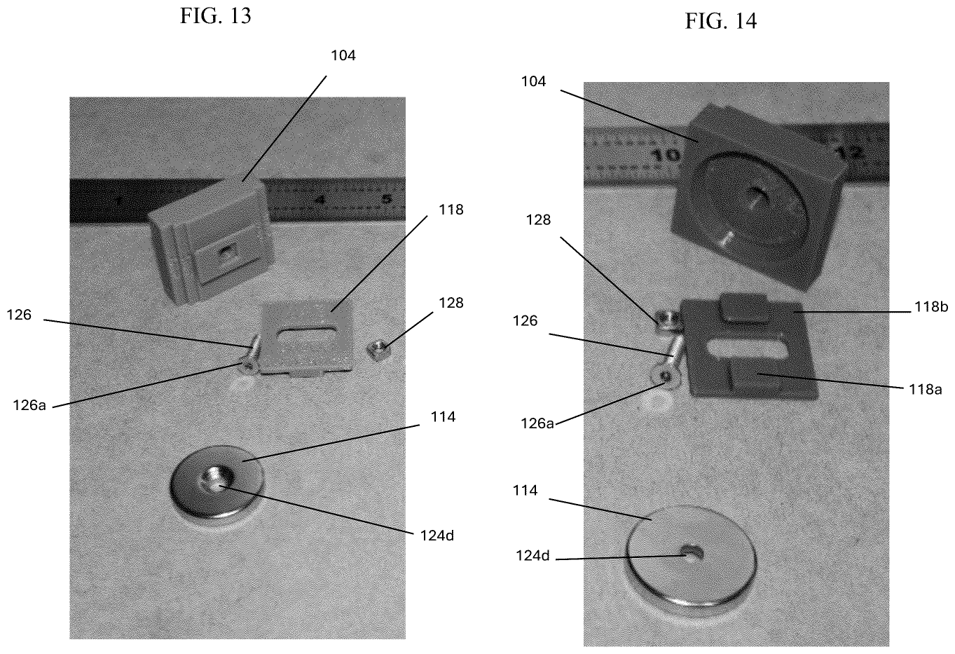

When the magnet 114 is inserted into the base lower end cavity 112 and the plate 118 is slid onto the upper end projection 120, a bar 126 is inserted through the magnet opening 124d, through the base opening 124b, through the projection opening 124a, and through the plate opening 124c, to connect with a square nut 128. The device 102 is then assembled and ready for use. As shown in FIG. 13, the elongated bar includes a flat head 126a having a width that corresponds with the width of the magnet opening 124d such that when the bar is inserted into the device, its head is flush with the magnet outer surface. As shown in FIGS. 10, 13 and 14, the upper end through opening and the insert have rectangular configurations.

Preferably, the device of FIGS. 8-15 includes a neodymium disk countersunk hole magnet (30 mm diameter, 5 mm thick, 5 mm countersunk hole), a square nut (M4 thread, 7 mm each side, 3 mm height), and a flat head socket cap screw (M4 thread, 16 mm total length).

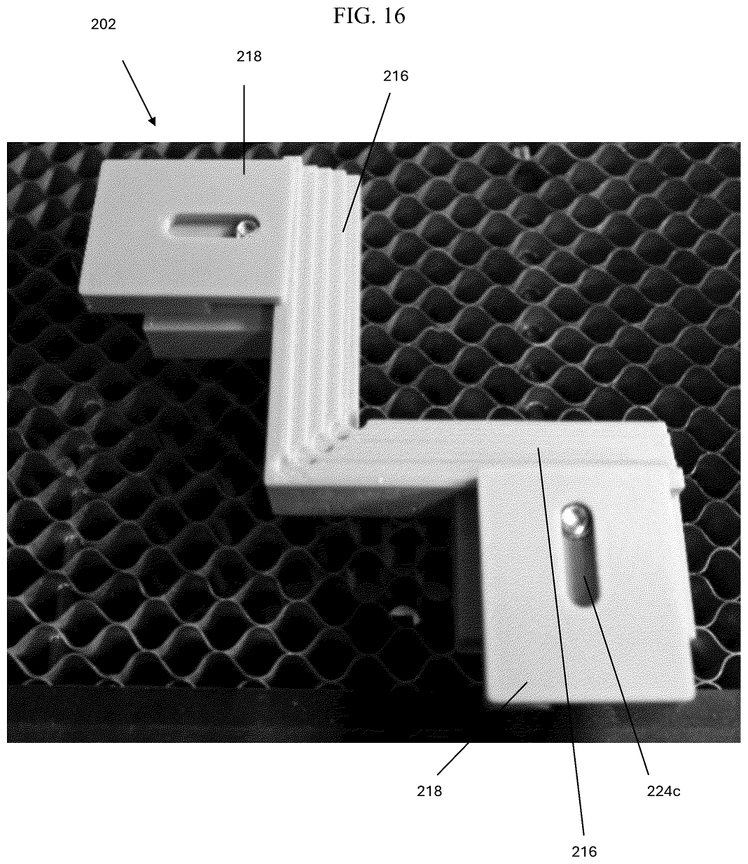

Referring now to FIGS. 16-25, a third embodiment of a hold down device 202 according to the present disclosure is shown. This embodiment, also referred to as the laser stock elevated corner bracket hold down, includes a 90-degree corner bracket that bridges two hold downs with a corner component. All four shelves face the interior space delineated by the bracket. The hold down plate is the same as that of the second embodiment.

As with the first two embodiments, this embodiment includes a base 204 and upper end shelves 216 for a material that is to be cut. However, the device is a corner bracket configured to correspond with a corner of material to be cut or engraved.

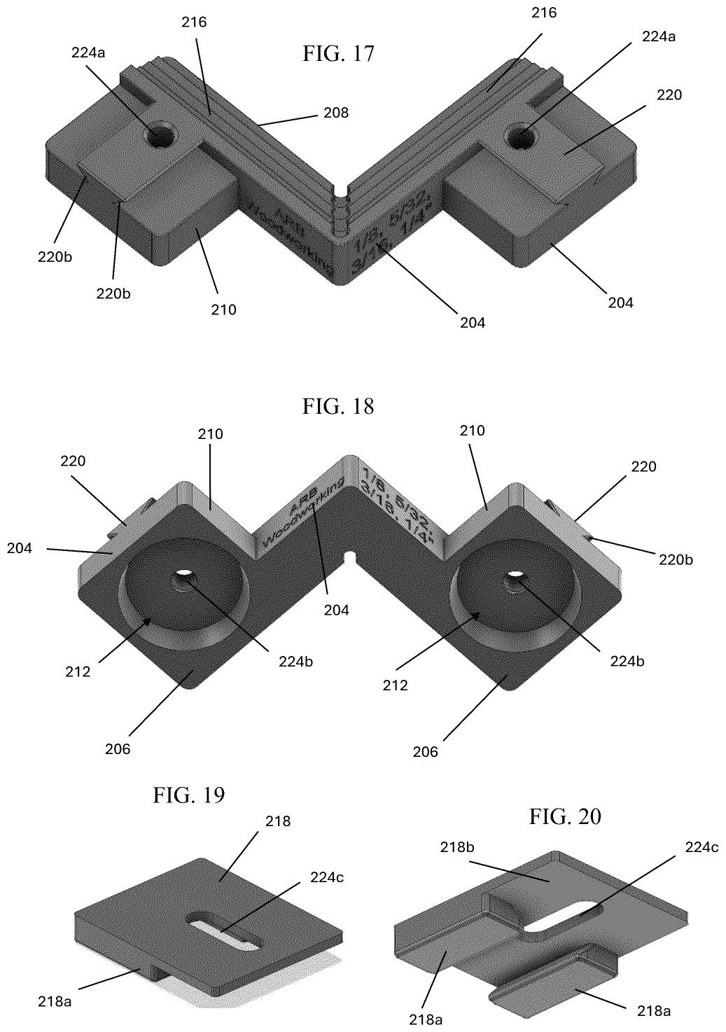

As shown in FIGS. 17 and 18 the shelf portion 216 has a generally L-shaped configuration with two rectangular base portions 204 at either end of the L arranged at a 90-degree angle relative to one another. These portions are configured similar to the base of FIGS. 8-15 with a lower end cavity 212 for a magnet 214 and upper end projection 220 with inwardly angled sidewalls 220b. Unlike with the rectangular base of FIG. 8-15, the rectangular base portion of this embodiment does not include shelves on either side of the upper end projection. This embodiment is similar to using two of the embodiments of FIGS. 8-15 but that the L-shaped shelf portion of the base provides significantly more support to material.

Referring again to FIGS. 16-25, there is a plate 218 for each of the rectangular base portions. As with the plates of the embodiment of FIGS. 8-15, there are a pair of protrusions 218a connected with the bottom surface 218b of each plate on either side of the plate openings, which have side wall surfaces that correspond with the upper end projection angled sidewalls 220b. As is shown in FIGS. 19 and 20, the plate opening does not extend substantially along the width of the plate but, rather, it extends along a portion of the plate upper surface. Moreover, rather than being centrally arranged, the protrusions of the plates extend from a side edge to a central portion of the plate. Similar to the plate of FIGS. 8-15, one plate is slid onto each projection and then can be slid from first and second positions, exposing and covering portions of the base shelves.

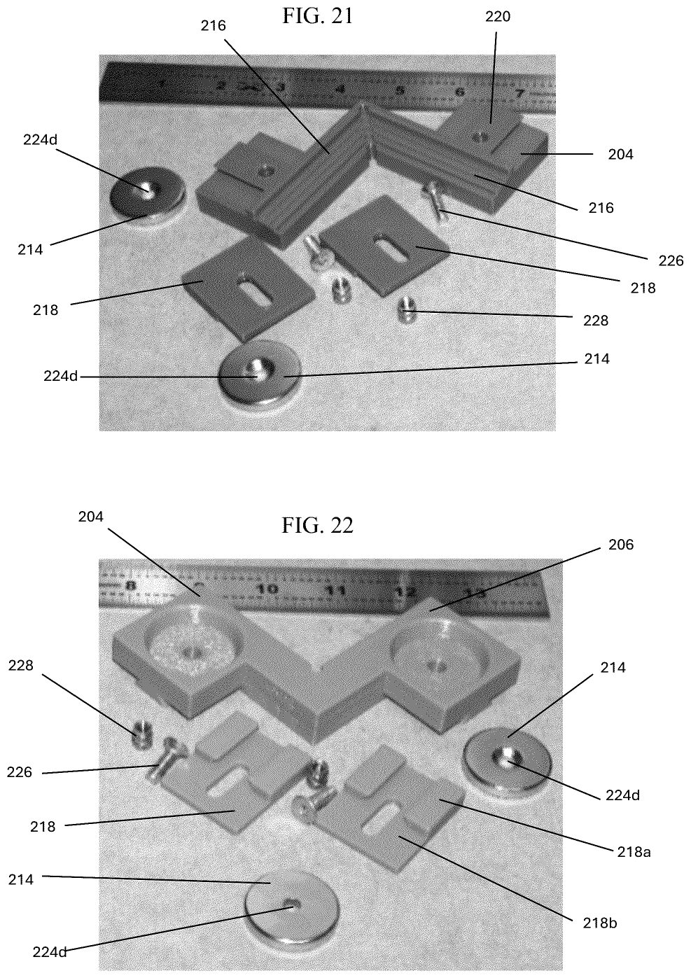

When a magnet is inserted into the cavity of each of the rectangular base portions and a plate is slid onto each upper end projection, a bar is inserted through an opening in the magnet, then through the base opening, projection opening, and plate opening to connect with a threaded insert. The threaded insert is a heat-set insert that must be heated and inserted into the base. The device is then assembled and ready for use. As shown in FIGS. 21 and 22, the elongated bar includes a flat head having a width that corresponds with the width of the magnet opening such that when the bar is inserted into the device, its head is flush with the magnet outer surface.

Preferably, this device includes neodymium disk countersunk hole magnets (30 mm diameter, 5 mm thick, 5 mm countersunk hole), knurled brass heat set inserts (M5 thread, 8 mm height, 7 mm diameter) for each projection, and flat head socket cap screws (M5 thread, 16 mm total length) for each end of the device

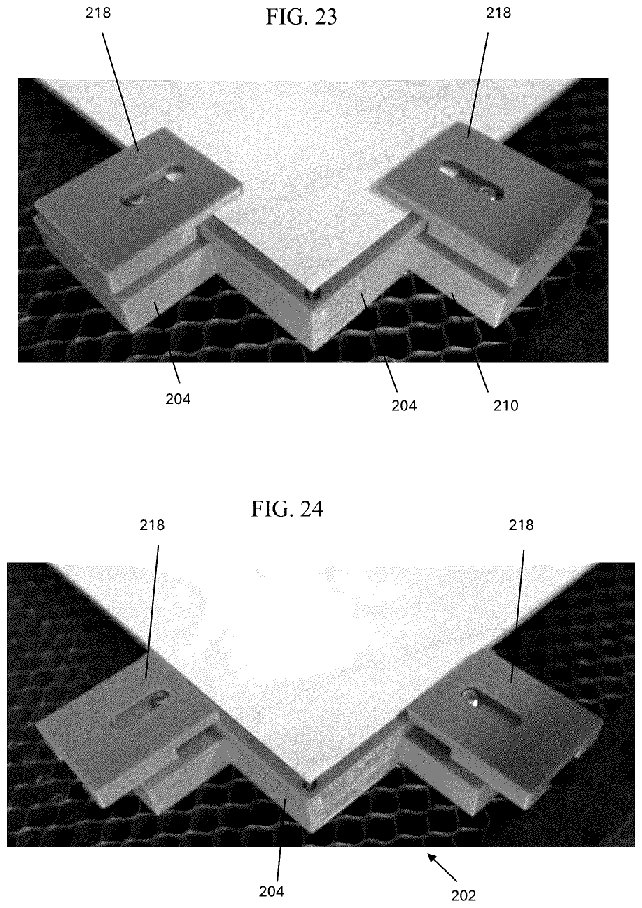

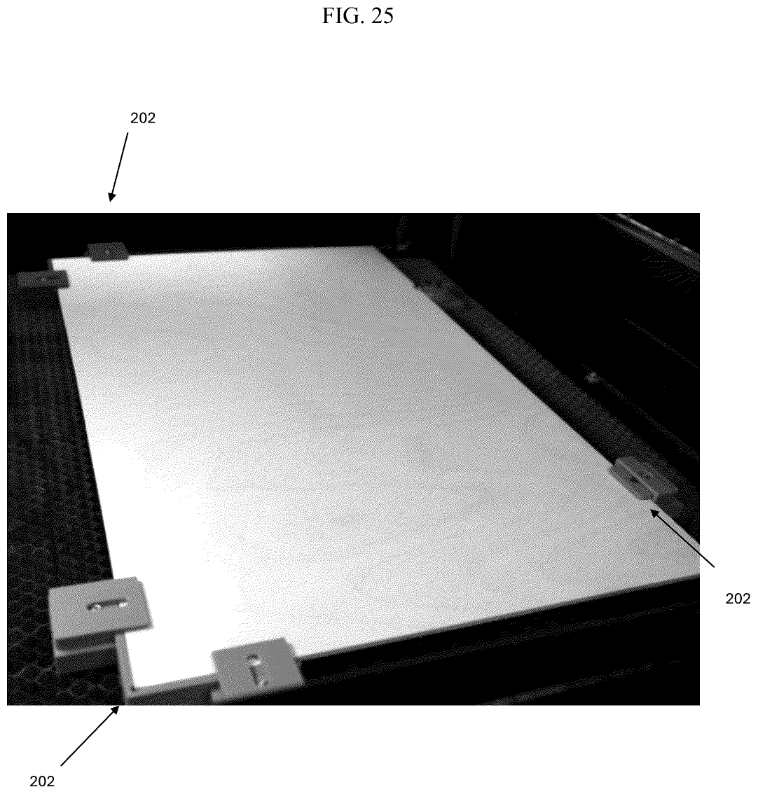

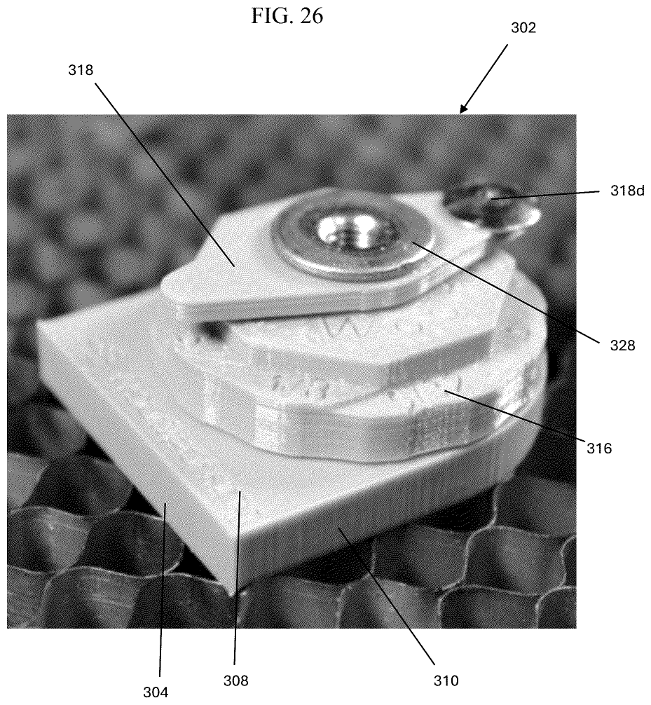

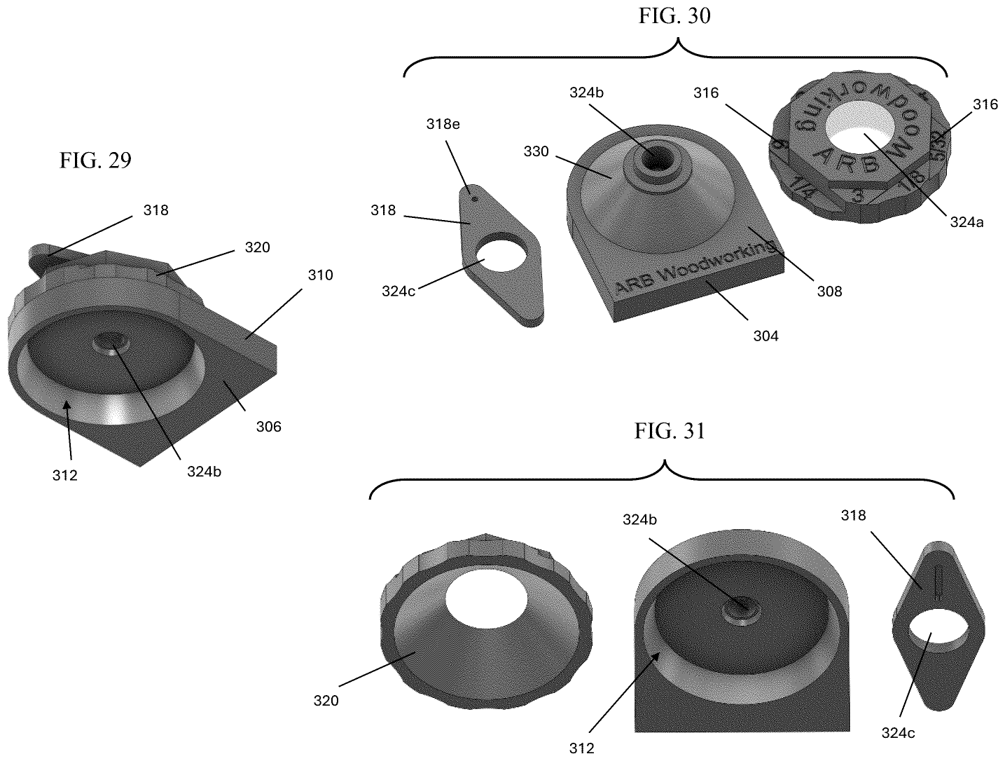

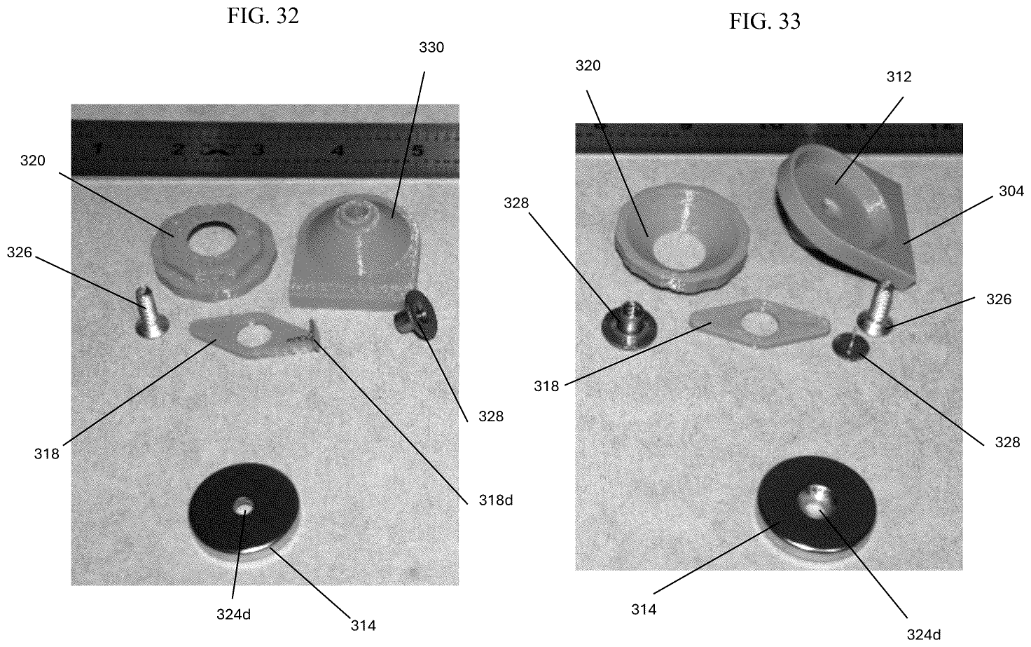

FIGS. 23 and 24 demonstrate how material is secured and released with this device. To secure the material, the two plates are slid to one end such that the plate overhangs the shelves and engages with the material. To release the material, the plate is slid to the opposite end such that it overhangs the outward side of the base rectangular portion and disengages with the material. FIG. 25 shows two of the devices of this embodiment securing one side of material to be cut, one device from the embodiment of FIGS. 1-7, and another device from the embodiment of FIGS. 26-33.

Referring to FIGS. 26-34, a fourth embodiment of a hold down device according to the present disclosure is shown. This embodiment, also known as the rotating laser stock elevated hold down, includes a central rotating structure having eight shelves that support both metric and standard thickness materials. A rotating plate/tab is used in place of the of a sliding plate as described above. Owing to the minimal material that contacts stock material when being used, one end of the rotating tab is protected by a metal component to ensure that it is not cut by a stray laser beam. This component is described below as a tack, though other metal components could be used without deviating from the scope or spirit of this embodiment.

This device 302 includes a base 304 with lower end cavity 312 for a magnet 314, upper end shelves 316 and a rhomboidal plate 318. Different from the other embodiments disclosed herein, the shelves of this embodiment are detachable rather than being integral.

The base 304 has a generally semicircular configuration with a rectangular portion at one end. There is a frustum 330 arranged on the base above the circular cavity 312 and on which the substantially circular shelf portion 320 is placed. As shown in FIG. 30, there are a plurality of shelves 316 arranged around the outer edges of the circular shelf portion to provide varying depths on which material can be placed.

To assemble the device, a magnet 314 is placed in the base cavity 312, the shelf portion 320 is placed on the frustum 330 of the base 304, the rhomboidal plate 318 is arranged on top of the shelf portion, a screw 326 is inserted into the magnet and through the base to connect with a threaded tee nut 328. A tack 318d is inserted through an opening 318e in the plate and the plate is freely rotatable relative to the shelf portion. As noted above, other metal components could be used in place of the tack, to achieve the purpose of the tack, which is to ensure the plate/tab is not cut by a laser.

Preferably, the device of FIGS. 26-34 includes a neodymium disk countersunk hole magnet (30 mm diameter, 5 mm thick, 5 mm countersunk hole), a tee nut (M5 thread, 15 mm flange diameter, 6.5 mm shaft diameter, 8 mm total height, 1.2 mm flange thickness), a flat head socket cap screw (M5 thread, 16 mm total length), and a push pin/thumb tack (9.35 mm head diameter, 10 mm total height, 8.8 mm pin length, 1 mm pin diameter).

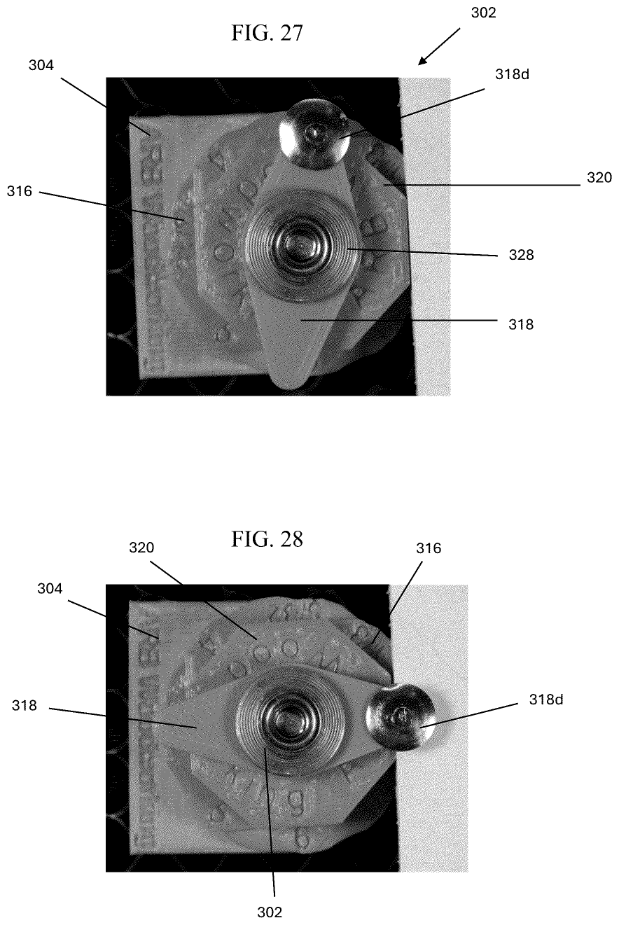

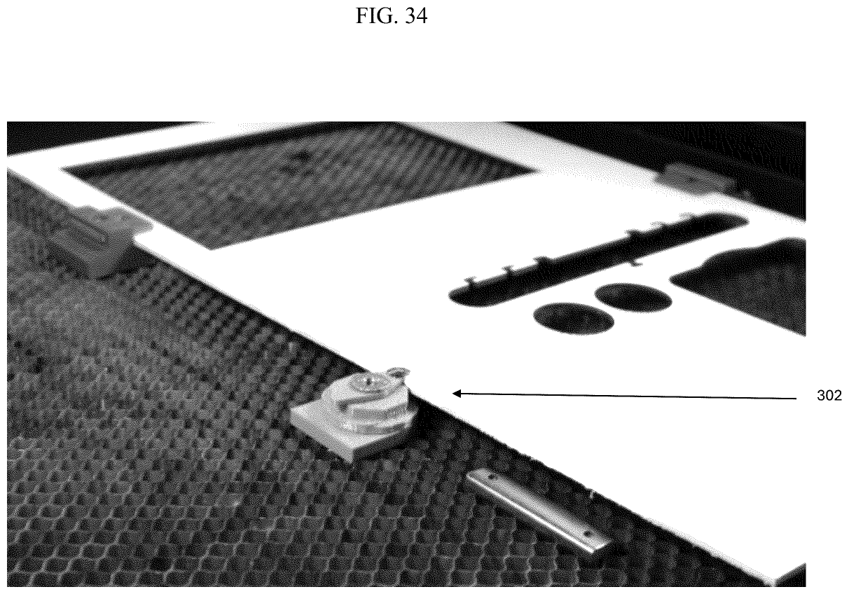

When in use, the base 304 of the device is arranged at an angle relative to an edge of the material to be secured for cutting or engraving and the rhomboidal plate 318 is rotated such that it engages with the material to hold the material between the plate and a shelf, as shown in FIGS. 28 and 34. The plate is rotated away from the material to disengage and free the material, as shown in FIG. 27.

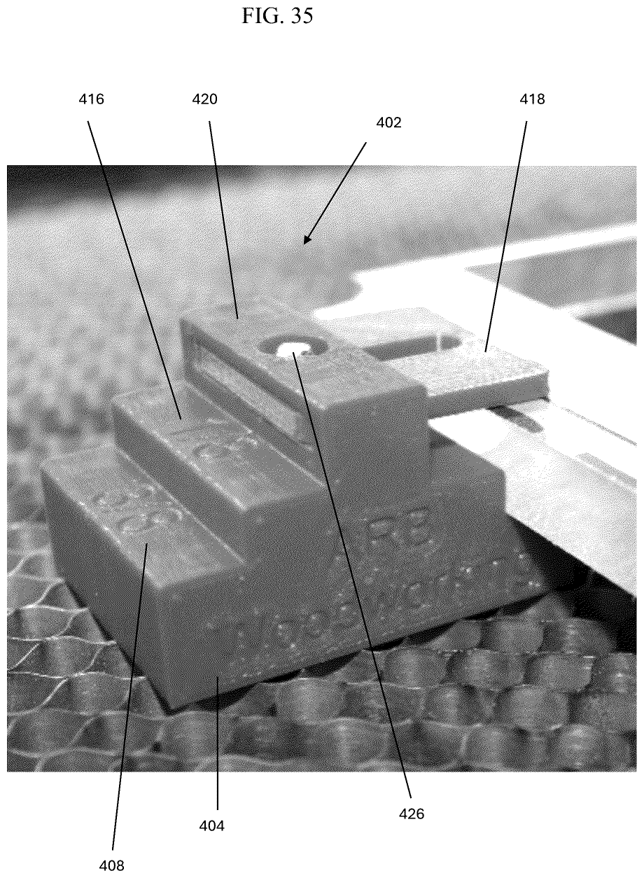

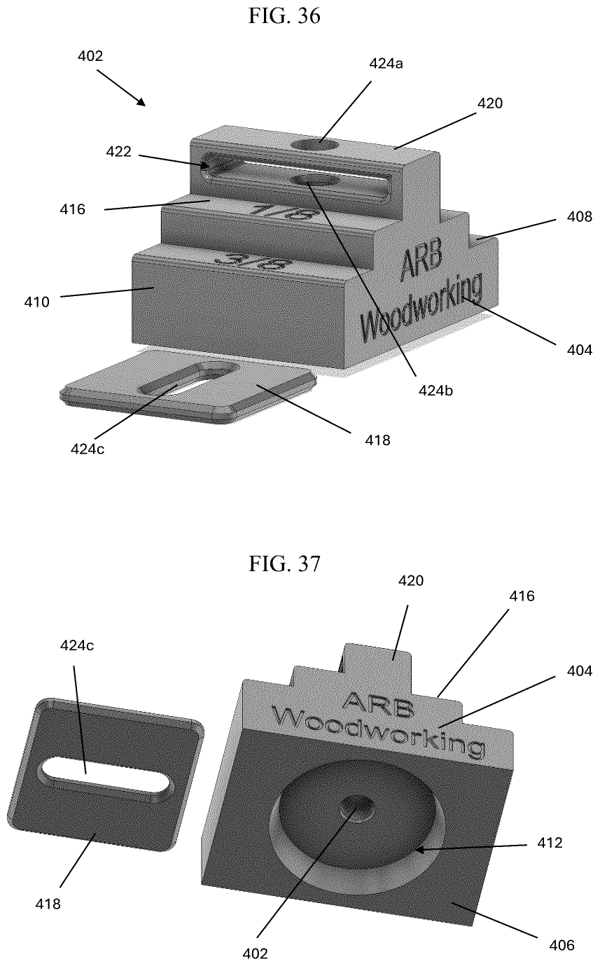

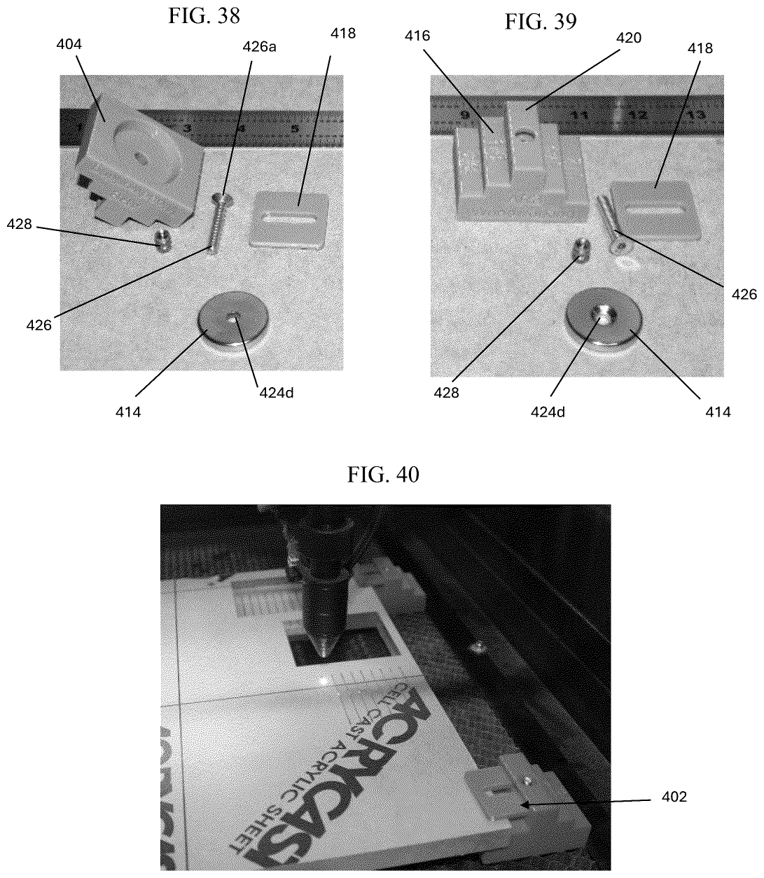

Referring now to FIGS. 35-40, a fifth embodiment of a hold down device according to the present disclosure is shown. This embodiment, also referred to as the laser stock elevated hold down for up to half inch thick materials, is a larger version of the first embodiment. The maximum stock material thickness for this embodiment is preferably ½ inch.

This device 402 is similar to the device of FIGS. 1-7 in that it includes a base 404 with cavity 412 for a magnet 414, shelves 416, upper end projection 420 having a horizontal through opening 422, and a plate 418 that inserts through the projection horizontal through opening. Moreover, this embodiment includes a screw 426 and knurled insert 428 to assemble and secure the device. The knurled insert is a heat-set insert that must be heated and inserted into the base. As is shown in FIGS. 35-40, this embodiment includes significantly greater thicknesses than with the embodiment of FIGS. 1-7 to secure thicker materials. FIG. 40 demonstrates how this embodiment secures thicker material.

Preferably, this device includes a neodymium disk countersunk hole magnet (30 mm diameter, 5 mm thick, 5 mm countersunk hole), a knurled brass heat set insert (M5 thread, 8 mm height, 7 mm diameter), and a flat head socket cap screw (M5 thread, 30 mm total length).

Although the above and accompanying descriptions reference particular embodiments, it is to be understood that these embodiments are merely illustrative of the principles and applications of the present disclosure. It is therefore to be understood that numerous modifications may be made to the illustrative embodiments and that other arrangements may be cd and employed without departing from the spirit and scope of the present disclosure.

What is claimed is:

1. A laser stock hold down device, comprising:
a. a base having a bottom wall, top wall and at least one side wall arranged therebetween;
b. at least one shelf connected with the base and arranged above the base bottom wall, a portion of the at least one shelf being arranged within a perimeter of the base; and
c. at least one hold down mechanism being connected with an upper surface of the base, the at least one shelf defining at least two horizontal surfaces on which material to be cut or engraved can be secured and raised above a laser bed, wherein a distance between each surface and the hold down mechanism differs.

2. The laser stock hold down device of claim 1, wherein the at least one hold down mechanism is movable between a first position for securing material to be cut or engraved and a second position for releasing the material.

3. The laser stock hold down device of claim 2, and further including at least one projection connected with an upper end of the base, the at least one hold down mechanism being connected with the projection.

4. The laser stock hold down device of claim 3, and further including at least one magnet arranged within a cavity of the base bottom wall.

5. The laser stock hold down device of claim 4, wherein the base, at least one magnet and at least one projection each include an aligned through opening, a bar being arranged in the through opening to connect the base, magnet and projection.

6. The laser stock hold down device of claim 5, the at least one hold down being one of slidable and rotatable.

7. The laser stock hold down device of claim 6, wherein the at least one shelf includes a plurality of shelves having an L configuration and the at least one hold down includes two hold downs arranged at opposite ends of the shelves.

8. The laser stock hold down device of claim 2, wherein at least a portion of an upper surface of the base has a frustum configuration.

9. The laser stock hold down device of claim 8, wherein the at least one hold down mechanism has a rhomboidal configuration and the at least one shelf includes a plurality of shelves arranged in a generally circular configuration.

10. The laser stock hold down device of claim 3, wherein the at least one projection contains a horizontal through opening having a configuration that corresponds with a configuration of the at least one hold down mechanism.

11. The laser stock hold down device of claim 3, wherein the at least one projection includes a pair of opposing inwardly angled sidewalls, the at least one hold down mechanism including a pair of spaced protrusions arranged on a bottom surface of the hold down mechanism and being configured to correspond with the projection inwardly angled sidewalls, the at least one hold down mechanism being connected with the at least one projection via a sliding motion.
